(19) United States
(12) Patent Application Publication
(10) Pub. No.: US 2016/0261758 A1
(43) Pub. Date: Sep. 8, 2016

(54) READING DEVICE, IMAGE FORMING APPARATUS INCLUDING READING DEVICE, AND METHOD FOR CONTROLLING READING DEVICE

(71) Applicant: KYOCERA Document Solutions Inc., Osaka (JP)

(72) Inventor: Koichi KIMURA, Osaka (JP)

(73) Assignee: KYOCERA Document Solutions Inc., Osaka (JP)

(21) Appl. No.: 15/056,389

(22) Filed: Feb. 29, 2016

(30) Foreign Application Priority Data
Mar. 2, 2015 (JP) 2015-039916

(51) Int. Cl. H04N 1/00

(52) U.S. Cl. CPC H04N 1/0066; H04N 1/0032; H04N 1/00588; H04N 1/0071; H04N 1/00721; H04N 1/00411; H04N 1/00774; H04N 2201/0094

(57) ABSTRACT

A reading device includes a document feeder unit, an image reading unit, an operation unit, a control unit, and an image processing unit. The image processing unit generates read image data on the basis of image data generated by the image reading unit and a document size determined by the control unit, rotates the read image data in a direction opposite to an inclination direction so as to reduce the inclination as an inclination correction process. In a document mixed mode, read image data of a largest width document sheet is rotated so that the inclination is reduced for the inclination correction process of the largest width document sheet, while the inclination correction process corresponding to a selected inclination correction mode is performed on read image data of a small width document sheet.

### INCORPORATION BY REFERENCE

This application is based upon and claims the benefit of priority from the corresponding Japanese Patent Application No. 2015-033916 filed Mar. 2, 2015, the entire contents of which are hereby incorporated by reference.

### BACKGROUND

The present disclosure relates to a reading device for reading a document. The present disclosure also relates to an image forming apparatus including the reading device.

The reading device reads a document so as to generate image data. When the document is set in an inclined state, an image contained in the generated image data is also inclined. Accordingly, in order to correct the inclination, a rotation process may be performed on the image data obtained by reading. There is known an image forming apparatus that performs the rotation process for inclination correction as described below.

Specifically, there is known an image forming apparatus, which sets a rotation angle on the basis of a two-dimensional input image, rotates the two-dimensional input image by the set rotation angle, performs a smoothing process on the rotated image, and performs the smoothing process only in a half tone image region of the rotated image. With this structure, the smoothing correction is performed only on a half tone image part. On the contrary, the smoothing process is not performed on a character image (simple binary image), which may cause deterioration of image quality. This image forming apparatus aims at reducing deterioration of image quality of the rotated image.

The reading device for reading a document so as to generate image data may be equipped with a document feeder unit for feeding document sheets to a reading position (which may be called variously such as a “document feeding device”, an “automatic document feeding device”, a “DP”, or an “ADF”). In addition, there is an image forming apparatus that can use a document mixed mode in which a plurality of types of document sheets having different sizes can be set in the document feeder unit and can be read.

### SUMMARY

A reading device according to one aspect of the present disclosure includes a document feeder unit, an image reading unit, an operation unit, a control unit, and an image processing unit. The document feeder unit includes a document tray on which a document sheet is set with a regulation plate for regulating a position of the document sheet, and a detection sensor unit disposed in a document feeding path so as to detect a document size, a document inclination direction, and a document inclination angle in a main scanning direction, so as to feed the set document sheet to a reading position. The image reading unit reads the document sheet fed by the document feeder unit. The operation unit receives an operation for selecting one of a plurality of types of inclination correction modes prepared for inclination correction of read image data of a small width document sheet having a width smaller than a largest width of set document sheets in a document mixed mode in which a plurality of types of document sheets having different sizes are set on the document tray for reading. The control unit determines the document inclination direction and the document inclination angle on the basis of an output of the detection sensor unit, and recognizes the document size on the basis of an operation to the operation unit or an output of the detection sensor unit. The image processing unit generates the read image data as a result of reading on the basis of image data generated by the image reading unit and the document size determined by the control unit, performs a process of decreasing inclination by rotating the read image data in a direction opposite to the inclination direction as an inclination correction process, and in the document mixed mode, rotates the read image data of a largest width document sheet so that the inclination is decreased as the inclination correction process for a largest width document sheet, while performs the inclination correction process corresponding to the selected inclination correction mode on the read image data of the small width document sheet.

Further features and advantages of the present disclosure will become apparent from the description of embodiments given below.

### BRIEF DESCRIPTION OF THE DRAWINGS

FIG. 1 is a diagram illustrating an example of a multifunction peripheral according to an embodiment.

FIG. 2 is a diagram illustrating an example of a hardware structure of the multifunction peripheral according to the embodiment.

FIG. 3 is a diagram illustrating an example of a reading device according to the embodiment.

FIG. 4 is a diagram illustrating an example of a hardware structure of the reading device according to the embodiment.

FIGS. 5A and 5B are explanatory diagrams of reading document sheets in a document mixed mode.

FIG. 6 is a diagram illustrating an example of detecting a document width in a main scanning direction by using a detection sensor unit according to the embodiment.

FIG. 7 is a diagram illustrating an example of detecting a document inclination direction and a document inclination angle by using the detection sensor unit according to the embodiment.

FIG. 8 is a diagram illustrating an example of detecting a document inclination direction and a document inclination angle by using the detection sensor unit according to the embodiment.

FIG. 9 is a diagram illustrating an example of a mode selection screen according to the embodiment.

FIG. 10 is a diagram illustrating a partial loss of image when an inclined document sheet is read.

FIG. 11 is a flowchart showing an example of a flow of an inclination correction process in a first mode of the reading device according to the embodiment.

FIG. 12 is a diagram illustrating an example of a result check screen of a small width document sheet read by the reading device according to the embodiment.

FIG. 13 is a diagram for explaining a margin recognition mode according to the embodiment.

FIG. 14 is a flowchart showing an example of a flow of the inclination correction process in a second mode of the reading device according to the embodiment.

### DETAILED DESCRIPTION

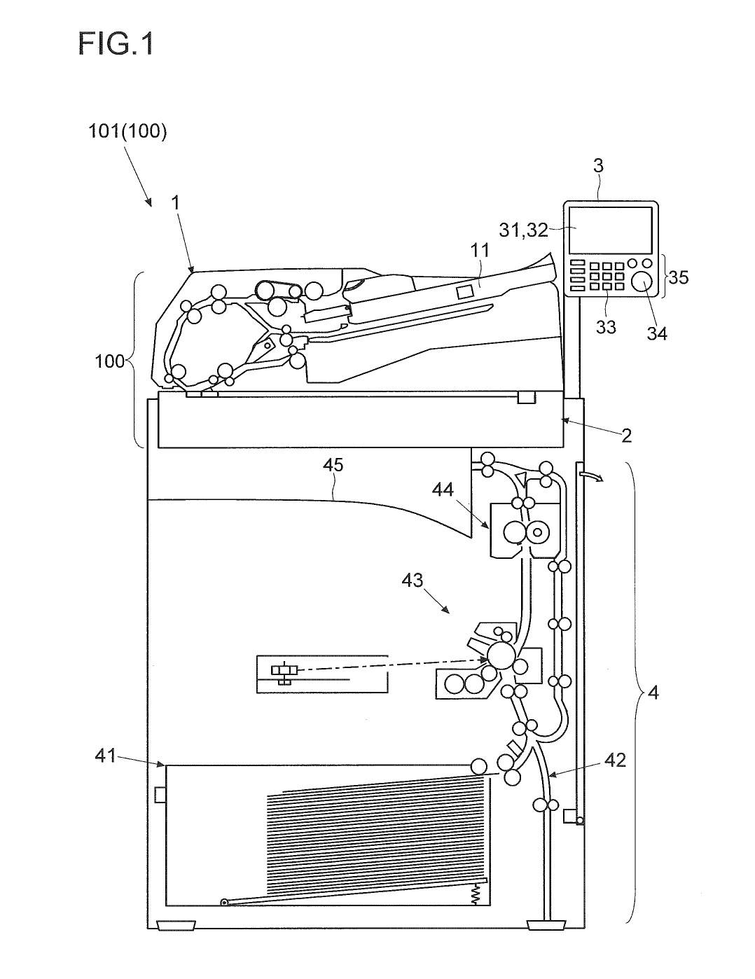

In the present disclosure, when document sheets having different widths in the main scanning direction are set and read in the document mixed mode, the inclination correction process corresponding to the width of each document sheet in the main scanning direction is performed. An appropriate inclination correction process is performed regardless of a document width. Hereinafter, with reference to FIGS. 1 to 14, a multifunction peripheral 101 (corresponding to the image forming apparatus) including a reading device 100 according to the embodiment is described. Note that elements such as structures and layouts described in each embodiment are merely examples for description and do not limit the scope of the disclosure.

(Outline of Multifunction Peripheral 101)

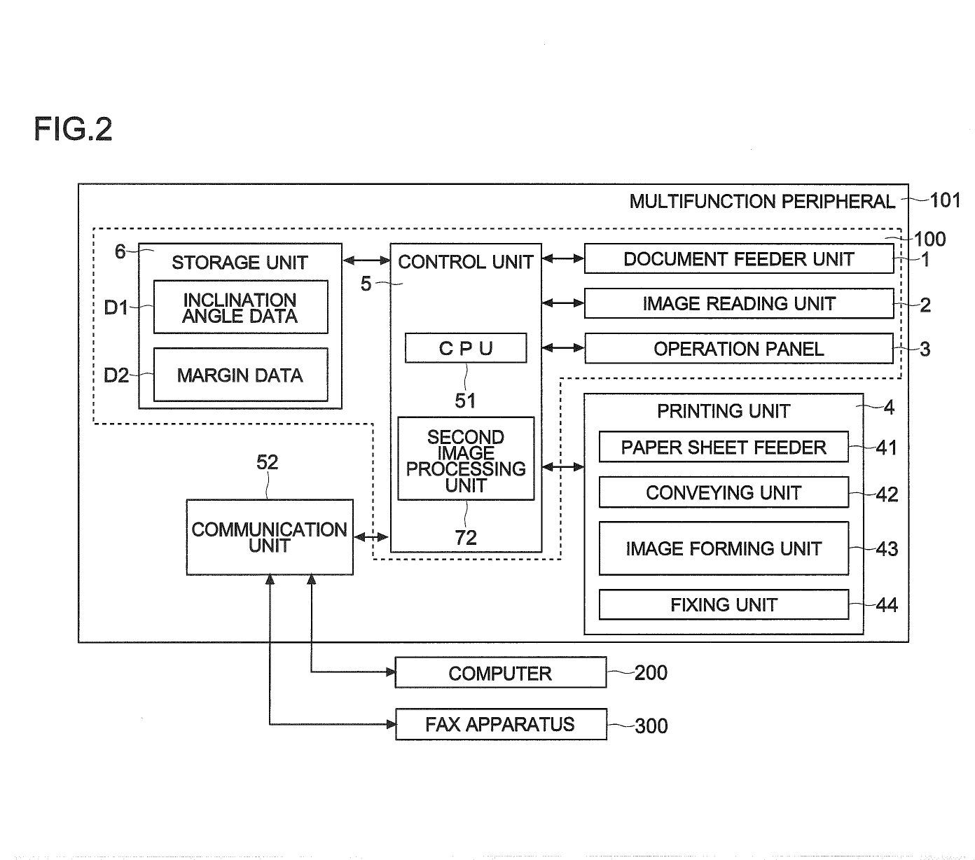

First, with reference to FIGS. 1 and 2, an outline of the multifunction peripheral 101 according to the embodiment is described. As illustrated in FIG. 1, the multifunction peripheral 101 includes the reading device 100 disposed on the upper part. Details of the reading device 100 will be described later. In addition, the multifunction peripheral 101 includes an operation panel 3 attached to an upper right side. The operation panel 3 includes a display panel 31 and a touch panel unit 32 (corresponding to the operation unit). The display panel 31 displays software keys for setting operation and setting screens. The touch panel unit 32 is used for recognizing a touch position and an operated software key. In addition, the operation panel 3 also includes a ten-key unit 33 for inputting numbers and hardware keys 35 (corresponding to the operation unit) such as a start key 34 for instructing start of job execution. A user performs an operation to the software keys and the hardware keys 35. In addition, the operation panel 3 also accepts user's operations and settings concerning jobs (a copy job and a transmission job) accompanied with reading of document sheets D.

Specifically, the operation panel 3 allows the display panel 31 to display the setting screens and keys, and accepts an input for determining a size of the document sheet D set in the reading device 100 (on a document tray 11). In addition, the operation panel 3 accepts setting for performing a job accompanied with setting and reading document sheets D having different sizes on the document tray 11 (setting of the document mixed mode). Other than that, the operation panel 3 accepts various settings such as the number of set document sheets D, a reading resolution, a selection of color reading or monochrome reading.

In addition, the multifunction peripheral 101 includes a printing unit 4 inside. The printing unit 4 includes a paper sheet feeder 41, a conveying unit 42, an image forming unit 43, and a fixing unit 44. The paper sheet feeder 41 stores a plurality of paper sheets and sends out the paper sheet when printing is performed. The conveying unit 42 conveys the paper sheet supplied from the paper sheet feeder 41 to the image forming unit 43. The image forming unit 43 forms a toner image based on image data to be printed and transfers the toner image onto the paper sheet. The fixing unit 44 heats and presses the paper sheet with the transferred toner image so that the toner image is fixed to the paper sheet. The paper sheet after completion of the printing is discharged onto a discharge tray 45.

In addition, as illustrated in FIG. 2, a control unit 5 (a control substrate) is disposed in the multifunction peripheral 101. The control unit 5 includes a CPU 51. The control unit 5 performs the entire control of the multifunction peripheral 101. The control unit 5 has a function of performing job operation control, a function of performing communication control, and a function of performing image processing. A storage unit 6 stores programs and data for controlling the multifunction peripheral 101 and various data such as the image data. The storage unit 6 is a combination of volatile and nonvolatile storage devices, including a RAM, a ROM, an HDD, and a flash ROM. The CPU 51 performs calculation processes, sending and receiving control signals on the basis of the programs and data stored in the storage unit 6, so as to control the multifunction peripheral 101.

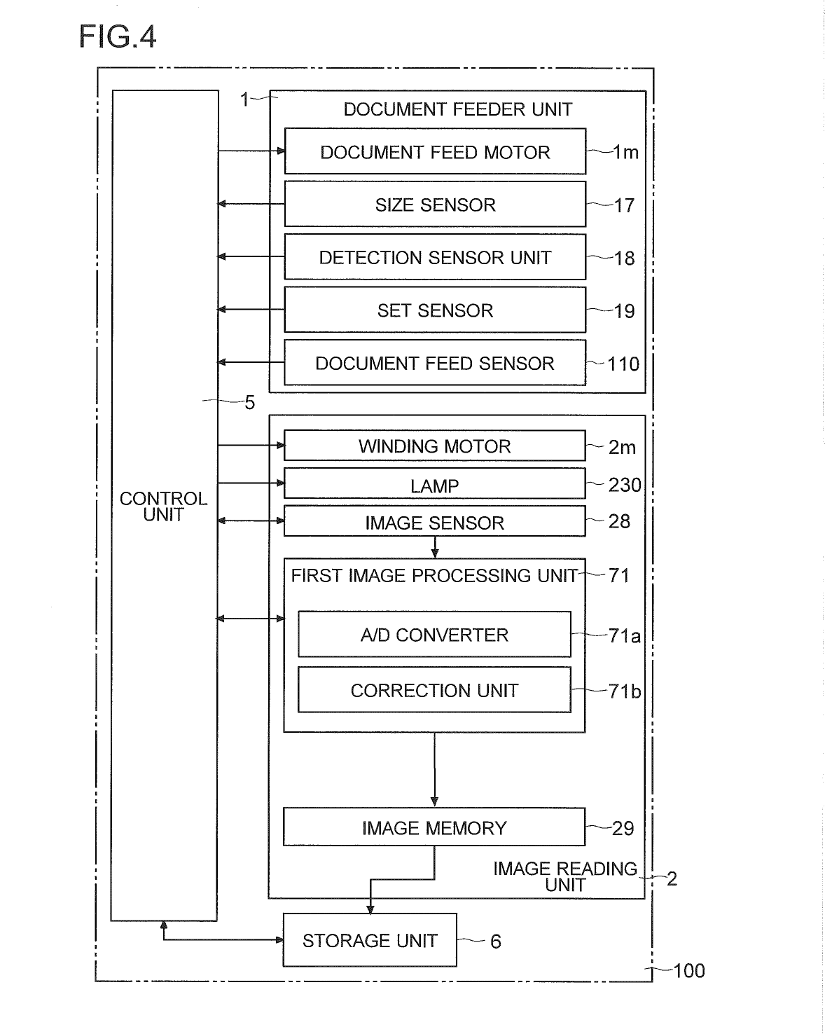

In addition, a second image processing unit 72 (corresponding to the image processing unit) included in the control unit 5 performs image processing on the image data such as read image data generated by a first image processing unit 71 (corresponding to the image processing unit, details of which are described later, see FIG. 4) on the basis of document reading, so as to generate image data to be used for a job such as copying or transmission. The second image processing unit 72 is a circuit including an ASIC and a memory, and is capable of performing various known image processing such as density conversion, scaling, compression and expansion, and data format conversion.

The second image processing unit 72 performs a rotation process as an inclination correction process for correcting inclination of the read image data (the rotation process may be performed by the first image processing unit 71). The second image processing unit 72 performs the rotation process with respect to a rotation center point that is the center of the read image data. For instance, the second image processing unit 72 performs the rotation process using a coordinate conversion by an affine transformation in which coordinates of the image before the rotation referred by the coordinates after the rotation are calculated, so as to generate the image data after the rotation process.

In addition, the control unit 5 is connected to the operation panel 3 in a communicable manner. Contents of setting and input performed with the operation panel 3 are transmitted to the control unit 5. The control unit 5 controls the units used for the job such as the image processing unit, a document feeder unit 1, an image reading unit 2, the printing unit 4, the storage unit 6, and a communication unit 52 so that a job result corresponding to the set content can be obtained.

The control unit 5 is connected to the communication unit 52. The communication unit 52 communicates with a FAX apparatus 300 and a computer 200 such as a PC or a server via a network, a cable, or a communication network. In this way, the multifunction peripheral 101 can receive the image data from the computer 200 so as to print the same (a printer function), and can store the image data read by the image reading unit 2 in the storage unit 6, so as to transmit the same to the computer 200 or the FAX apparatus 300 (a scanner transmission function).

(Structure of Reading Device 100)

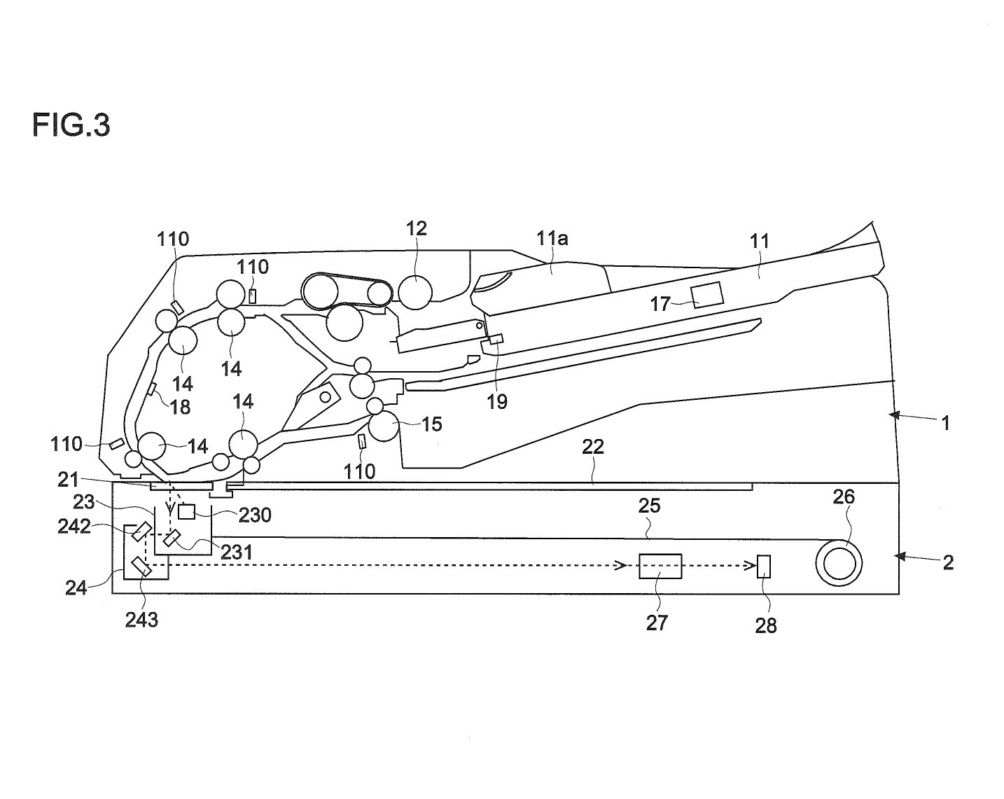

Next, with reference to FIGS. 3 and 4, an example of the reading device 100 according to the embodiment is described.

The reading device 100 includes the document feeder unit 1 and the image reading unit 2. The document feeder unit 1 feeds the set document sheets D one by one automatically and continuously to the reading position (a feed-reading contact glass 21). The document feeder unit 1 includes, in order from an upstream side in a document feed direction, the document tray 11, a document feed roller 12, a document feed path 13, a plurality of document feed roller pairs 14, a document discharge roller pair 15, and a document discharge tray 16. In addition, the document feeder unit 1 is attached to the image reading unit 2 in an openable and closable manner in an up and down direction with a pivot on the rear side of the paper plane of FIG. 2. The document feeder unit 1 functions as a cover pressing down the contact glasses of the image reading unit 2.

The document sheets are set on the document tray 11. The document tray 11 is equipped with a pair of regulation plates 11a, which move to slide in a width direction of the document sheet D (the main scanning direction, a direction perpendicular to the paper plane of FIG. 2) and sandwich the document sheets D so as to regulate the place position. After setting the document sheets D, the user moves the regulation plates 11a to slide so that the document sheets D are not shifted or inclined. In this way, the document tray 11 is a part on which the document sheets D are set and includes the regulation plates 11a for regulating the position of the document sheets D.

The control unit 5 is connected to the document feeder unit 1, the image reading unit 2, and the like in a communicable manner. The control unit 5 controls document feeding by the document feeder unit 1, document reading by the image reading unit 2, and generation of the image data. Note that the document feeder unit 1 may be equipped with a document feed control unit for controlling an operation of the document feeder unit 1 in accordance with an instruction from the control unit 5. In other words, a part of the control unit 5 may be divided, and a substrate for controlling the document feeder unit 1 may be disposed in the document feeder unit 1. In addition, the image reading unit 2 may be equipped with a read control unit for controlling an operation of the image reading unit 2 in accordance with an instruction from the control unit 5. In other words, a part of the control unit 5 may be divided, and a substrate for controlling the image reading unit 2 may be disposed in the image reading unit 2. In this description, there is described an example in which the control unit 5 controls the document feeder unit 1 and the image reading unit 2 as the document feed control unit and the read control unit.

When an operation of the start key 34 (an input for reading the document) is performed in a state where the document sheets D are set on the document tray 11, the document feed roller 12 sends out the document sheets D one by one to the document feed path 13 while securing a constant interval between document sheets. The sent-out document sheet D is guided and fed by the plurality of document feed roller pairs 14 and a guide. Then, the document sheet D passes the upper surface of the feed-reading contact glass 21 on the upper side of the image reading unit 2. The image reading unit 2 reads the passing document sheet D. Then, the document discharge roller pair 15 discharges the document sheet D after completion of reading onto the document discharge tray 16. Note that the rotating members for feeding the document sheet are driven to rotate by a document feed motor 1m (see FIG. 4) as a driving source.

In addition, the control unit 5 recognizes a size in the main scanning direction of the document sheet set on the document tray 11 on the basis of an output of a size sensor 17 disposed in the document feeder unit 1 (see FIGS. 3 and 4). The size sensor 17 is a sensor including a variable resistor having a resistance value that changes in accordance with a position of the regulation plate 11a, and an output value thereof changes in accordance with a position of the regulation plate 11a (another type of sensor may be used). In addition, in order to detect a rough size of the document sheet D in a sub scanning direction, the document tray 11 may be provided with a plurality of optical sensors as the size sensor 17 disposed along the sub scanning direction.

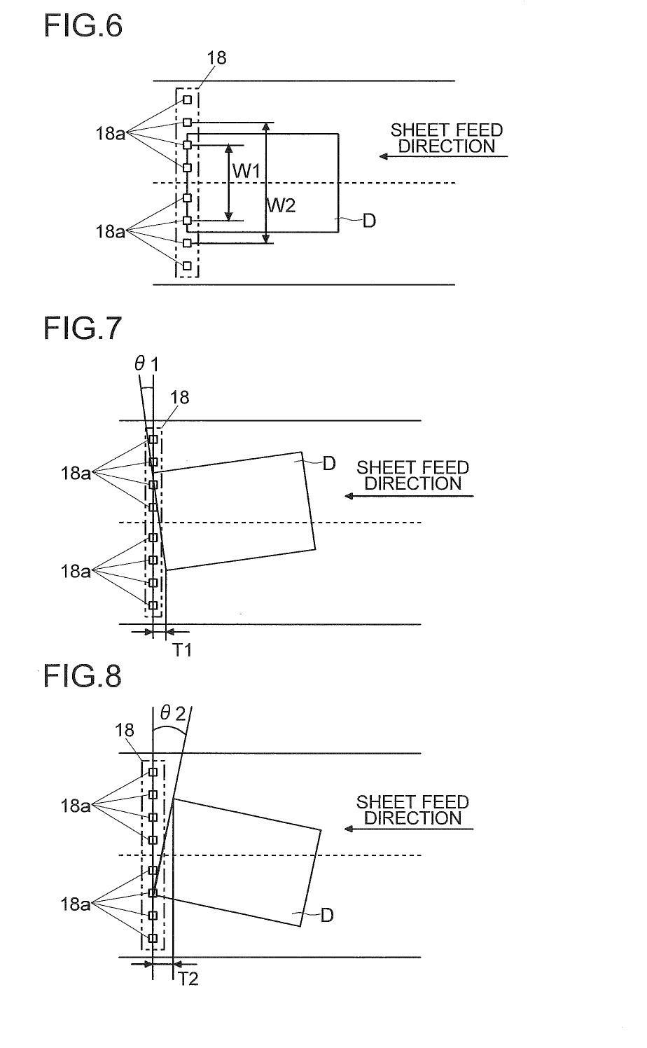

In addition, the document feeder unit 1 is provided with a detection sensor unit 18 for detecting a size of the document sheet D, an inclination direction of the same, and an inclination angle of the same, which is disposed in the feed path of the document sheets D (see FIGS. 6 to 8). The detection sensor unit 18 is constituted of a plurality of (eight in this embodiment) sensors 18a arranged in the main scanning direction, such as reflection type or transmission type optical sensors or ultrasonic sensors capable of detecting that the paper sheet has reached or passed. The control unit 5 detects a size in the main scanning direction and an inclination angle of the document sheet D on the basis of an output of the detection sensor unit 18 (details will be described later).

The control unit 5 recognizes whether or not the document sheet D is set on the document tray 11 on the basis of an output of a set sensor 19 disposed in the document feeder unit 1 (see FIGS. 3 and 4). The set sensor 19 is a sensor such as an optical sensor having an output value that changes depending on presence or absence of the document sheet on the document tray 11. When starting a job accompanied with reading the document sheet D in the state where the document sheet D is set on the document tray 11, the control unit 5 drives the document feed motor 1m to rotate the document feed roller 12 and the document feed roller pair 14.

In addition, a plurality of document feed sensors 110 (see FIG. 2, e.g., optical sensors) for detecting arrival or passage of the document sheet D are disposed in the document feed path 13. On the basis of outputs of the document feed sensors 110, the control unit 5 recognizes presence or absence of the document sheet D and arrival or passage of the document sheet D at a position (point) where the document feed sensor 110 is disposed.

Next, the image reading unit 2 is described. The transparent plate-like feed-reading contact glass 21 is disposed on an upper left side of the image reading unit 2. Further, a transparent plate-like place-reading contact glass 22 is disposed on an upper right side of the image reading unit 2. After lifting up the document feeder unit 1, a document D such as a book is placed on the place-reading contact glass 22 in a state where the surface to be read faces downward, and the document D can be read.

As illustrated in FIG. 3, a first moving frame 23, a second moving frame 24, a wire 25, a winding drum 26, a lens 27, and an image sensor 28 are disposed in a casing of the image reading unit 2. A lamp 230 for illuminating the document D with light, and a first mirror 231 for guiding reflection light from the document D to the lens 27 and the image sensor 28 are disposed in the first moving frame 23. A second mirror 242 and a third mirror 243 for guiding reflection light from the document D to the lens 27 and the image sensor 28 are disposed in the second moving frame 24.

When reading the document sheet D fed by the document feeder unit 1, after starting a winding motor 2m, the first moving frame 23 and the second moving frame 24 stops and rests at a position below the feed-reading contact glass 21 (the reading position). Then, the passing document sheet D is illuminated with light from the lamp 230. On the other hand, when reading the document D on the place-reading contact glass 22, the winding drum 26 and the wire 25 horizontally move the first moving frame 23 and the second moving frame 24 from a home position to the right in FIG. 3 (in the sub scanning direction), and a scanning operation is performed sequentially and continuously to an end of the document D so as to read the entire of the document D.

When reading the document D, the control unit 5 turns on the lamp 230. The light emitted from the lamp 230 is reflected by the document D and enters the lens 27 via the mirrors. The lens 27 condenses the reflection light, and the reflection light enters the image sensor 28. The image sensor 28 includes a charge coupled device (CCD) as the line sensor 18a, in which photoelectric conversion elements are linearly arranged in the main scanning direction. The image sensor 28 converts the reflection light into an analog electric signal corresponding to image density. The image sensor 28 reads the document D line by line on the basis of the reflection light from the document D. The image sensor 28 supports reading in colors.

In addition, the control unit 5 generates the read image data based on an analog output of the image sensor 28 and controls the first image processing unit 71 to perform image processing on the generated read image data. Note that there is described an example where the first image processing unit 71 is disposed in the image reading unit 2 while the second image processing unit 72 is disposed in the control unit 5, but it is possible to dispose only one image processing unit in which functions of the first image processing unit 71 and the second image processing unit 72 are integrated.

The first image processing unit 71 includes an ND converter 71a for digitizing the analog output of the image sensor 28 so as to convert into a digital signal. In addition, the first image processing unit 71 includes a correction unit 71b. The correction unit 71b performs adjustment of analog signal values and image processing such as gamma correction or shading correction for correcting a distortion due to reading characteristics on the read image data with respect to the digitized image data. Further, the read image data generated and processed by the first image processing unit 71 is stored in an image memory 29. The image memory 29 transmits the stored read image data to the storage unit 6. The second image processing unit 72 performs image processing necessary corresponding to the job to be executed on the read image data. Further, using the processed image data, a printing job or a transmission job is executed.

(Document Mixed Mode)

Next, with reference to FIGS. 2, and 4 to 6, document reading in the document mixed mode is described.

Using the reading device 100, it is possible to set document sheets D having the same size on the document tray 11 so as to read the document sheets D (a normal reading mode). For instance, when A4 size document sheets D are read in actual size, A4 size read image data are generated (so as to have the same size).

In addition, it is possible to set the document sheets D having different sizes in combination on the document tray 11 so as to read the document sheets D (the document mixed mode). For instance, when reading in actual size in the document mixed mode, an A4 size read image data (having the number of pixels corresponding to the A4 size) is generated corresponding to the A4 size document sheet D, and a B4 size read image data (having the number of pixels corresponding to the B4 size) is generated corresponding to the B4 size document sheet D. In other words, the read image data of a size corresponding to the size of each document sheet D is generated.

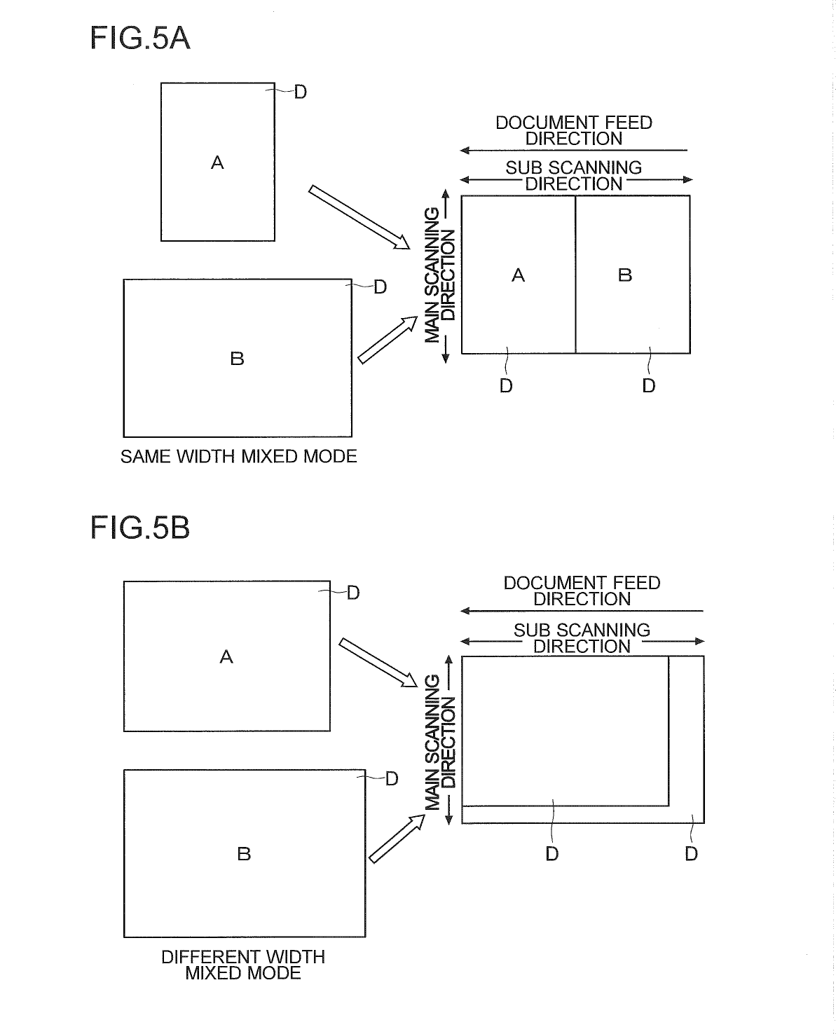

Next, with reference to FIGS. 5A and 5B, cases the document mixed mode are described. The document mixed mode of the reading device 100 (the multifunction peripheral 101) supports a case of setting document sheets D having the same width in the main scanning direction and different lengths in the sub scanning direction (the document feed direction) (a same width mixed mode as illustrated in FIG. 5A), and a case of setting document sheets D having different widths in the main scanning direction (a different width mixed mode as illustrated in FIG. 5B).

FIG. 5A illustrates an example of the same width mixed mode. In FIG. 5A, a sheet A has a smaller length in the sub scanning direction than a sheet B. As combinations of the same width mixed mode, there are combinations of a Ledger size and a Letter size, a Legal size and a Letter-R size, a B5 portrait size and a B4 landscape size, an A4 portrait size and an A3 landscape size, an A4 landscape size and a Folio size, and the like, for example.

On the other hand, FIG. 5B illustrates an example of the different width mixed mode. In FIG. 5B, a sheet A has a smaller width in the main scanning direction than a sheet B. There are many combinations of the different width mixed mode, such as the Ledger size and the Legal size, the Letter size and the Legal size, the B5 size and the A4 size, the B4 size and the A3 size, and the B4 size and the A4 size.

When reading in the document mixed mode, it is necessary to determine the document width in the main scanning direction and the length in the sub scanning direction of each of the read document sheets D. In the document mixed mode, it is possible to set the same width mixed mode or the different width mixed mode using the operation panel 3. In other words, the operation panel 3 accepts a user's instruction to read in the document mixed mode. The control unit 5 recognizes that the reading in the document mixed mode is set on the basis of an output of the operation panel 3.

When reading in the document mixed mode, the control unit 5 cannot determine sizes of the document sheets D before feeding. However, it is necessary to read from the front end to the rear end of the document sheet D both in the main scanning direction and in the sub scanning direction. Accordingly, the control unit 5 controls the image sensor 28 to read in the standard size having a largest length in the sub scanning direction among standard sizes of paper sheets that can be used by the reading device 100 (the multifunction peripheral 101) with the document width in the main scanning direction recognized on the basis of the size sensor 17. For instance, when the document width in the main scanning direction detected by the size sensor 17 matches the long side of the A4 size (the short side of the A3 size), the control unit 5 controls the image reading unit 2 to read the document sheet D in the A3 size.

In the same width mixed mode, the control unit 5 can recognize the document width in the main scanning direction of the document sheet D by using the size sensor 17. In addition, because a feed speed (a document feed amount per unit time) of the document sheet D is determined in advance, the control unit 5 determines a size in the sub scanning direction of the document sheet D by multiplying the feed speed of the document sheet D by a period of time from detection of arrival of the front end of the document sheet until detection of the rear end of the same D by the detection sensor unit 18 or the document feed sensor 110 (i.e., a period while presence of the document sheet D is detected). Note that other method may be used to determine the size in the sub scanning direction.

On the other hand, also in the different width mixed mode, concerning the length in the sub scanning direction of each document sheet D, the control unit 5 can determine the size in the sub scanning direction of the document sheet D by multiplying the feed speed of the document sheet D by a period of time from detection of the front end arrival of the document sheet D until detection of the rear end passage by the detection sensor unit 18 or the document feed sensor 110 (i.e., a period while presence of the document sheet D is detected). Note that other method may be used to determine the size in the sub scanning direction.

In addition, an example detecting the width in the main scanning direction in the different width mixed mode is described with reference to FIG. 6. The detection sensor unit 18 includes a plurality of sensors 18a such as optical sensors arranged in the main scanning direction (perpendicular to the sheet feed direction). Further, a broken line in FIG. 6 indicates a center line of the document feeding path. The document feeder unit 1 feeds the document sheet D so that the center of the feed path matches the center of the document sheet D as a rule (center feeding). Accordingly, the regulation plate 11a regulates a position of the document sheet D so that the center of the feed path matches the center of the document sheet D.

In the detection sensor unit 18, different sensors 18a detect arrival of the document sheet depending on the width in the main scanning direction of the document sheet D. The control unit 5 recognizes an approximate size in the main scanning direction of the document sheet D on the basis of outputs of the sensors 18a of the detection sensor unit 18. Specifically, the control unit 5 recognizes that a paper sheet width of the document sheet D is larger than an interval between both end sensors 18a that detect arrival of the paper sheet among the sensors 18a of the detection sensor unit 18 in the main scanning direction (W1 in FIG. 6). On the other hand, the control unit 5 recognizes that the paper sheet width is smaller than an interval between next outer sensors 18a of the sensors 18a that detect arrival of the paper sheet among the sensors 18a that cannot detect arrival of the paper sheet (W2 in FIG. 6).

In other words, the control unit 5 recognizes a range of the document width in the main scanning direction. Further, the control unit 5 recognizes that a standard size having the width within the document width range in the main scanning direction and the detected length in the sub scanning direction is the size of the document sheet D. Further, the first image processing unit 71 generates the read image data as a result of reading on the basis of the image data generated by the image reading unit 2 and the size of the document sheet D determined by the control unit 5. Specifically, when reading the document sheet D having a smaller size than a largest size of the set document sheets D, the first image processing unit 71 crops an area corresponding to the recognized document size from the image data of the standard size having the largest length in the sub scanning direction that can be used by the reading device 100 (the multifunction peripheral 101) with the document width in the main scanning direction recognized on the basis of the size sensor 17, so as to generate the read image data corresponding to the recognized document size.

(Detection of Inclination Direction and Inclination Angle)

Next, with reference to FIGS. 7 and 8, there is described a detection of the inclination direction and the inclination angle of the document sheet D by the reading device 100 according to the embodiment. FIGS. 7 and 8 are diagrams illustrating an example of the detection of the inclination direction and the inclination angle of the document sheet D using the detection sensor unit 18 according to the embodiment.

The control unit 5 determines the inclination direction and the inclination angle of the document sheet D on the basis of outputs of the sensors 18a of the detection sensor unit 18. The sensors 18a of the detection sensor unit 18 are arranged along the main scanning direction (in parallel to the main scanning direction). When the document sheet D is being fed in an inclined state (obliquely fed), a detection time point of the arrival (the front end) of the paper sheet is different among the sensors 18a of the detection sensor unit 18. On the basis of this difference, the inclination direction and the inclination angle of the document sheet D are determined.

FIG. 7 illustrates a state where the document sheet D is inclined by 8 degrees (θ1 in FIG. 7) in a counterclockwise direction with respect to the main scanning direction with reference to the lower side in FIG. 7. In FIG. 7, T1 represents a time (distance) difference between the sensors 18a that detect the paper sheet arrival first and last.

FIG. 8 illustrates a state where the document sheet D is inclined by 12 degrees (θ2 in FIG. 7) in a clockwise direction with respect to the main scanning direction with reference to the lower side of FIG. 8. In FIG. 8, T2 represents a time difference between the sensors 18a that detect the paper sheet arrival first and last.

As illustrated in FIGS. 7 and 8, as the inclination angle is larger, the time difference between the sensors 18a that detect the paper sheet arrival first and last becomes larger. Accordingly, the storage unit 6 stores inclination angle data D1 in which the inclination angles are determined with respect to the time differences between the sensors 18a that detect the paper sheet arrival first and last (see FIG. 2).

Further, the control unit 5 holds a time point when the arrival of the document sheet D is detected by each of the sensors 18a of the detection sensor unit 18. Further, the control unit 5 determines a time difference (temporal interval) between first and last ones of the held time points. The control unit 5 determines the inclination angle from the time difference and the inclination angle data D1 (detection of the inclination angle). In addition, the control unit 5 recognizes a direction (the clockwise direction or the counterclockwise direction) in which the document sheet D is inclined with respect to the main scanning direction with reference to a predetermined direction (the lower side in the example of FIGS. 7 and 8, namely the front side of the multifunction peripheral 101), on the basis of a positional relationship between the sensors 18a that detect the arrival of the paper sheet D first and last. In this way, the control unit 5 determines the inclination direction and the inclination angle of the document sheet D on the basis of the output of the detection sensor unit 18.

(Inclination Correction Process Mode of Small Width Document Sheet)

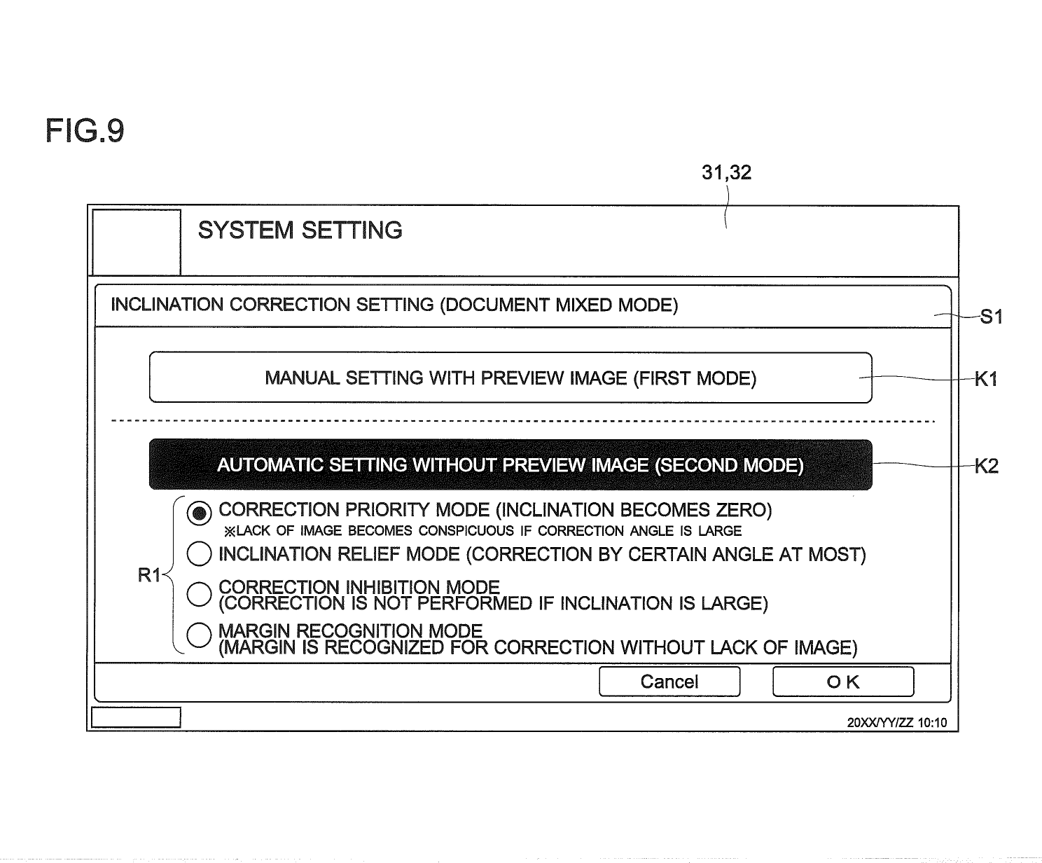

Next, with reference to FIG. 9, selection of an inclination correction mode of a small width document sheet is described.

Even in the document mixed mode, the document sheet D having the largest width in the main scanning direction among the set document sheets D is regulated in its set position by the regulation plate 11a, and hence the inclination thereof is not large. In addition, as to the document sheet D having a large width in the main scanning direction, when the inclination is large, jamming may occur, and the document feeding is stopped by the control unit 5 before reading by the image reading unit 2.

In the document mixed mode (different width mixed mode), the small width document sheet having a smaller width in the main scanning direction than the largest one may be fed and read without detection of jamming even if the inclination is large. As a result, an inclination of the read image data may be large. In the document mixed mode, it is preferred to use different contents of the inclination correction process for the document sheet D having the small width and for the document sheet D having the largest width.

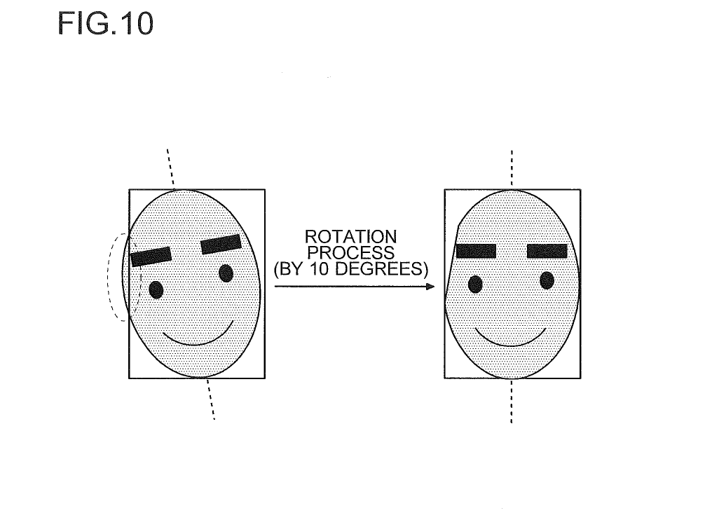

On the other hand, when the reading is performed in an inclined state, a missing part that is not read in the document sheet D may occur. With reference to FIG. 10, description is added. A left part of FIG. 10 illustrates an example of the read image data when the document sheet D is read in an inclined state by 10 degrees. The left part of FIG. 10 illustrates a state where a left end part of a figure on the document sheet D is out of the reading area due to the inclination.

A right part of FIG. 10 illustrates an example in which the read image data is rotated by 10 degrees in the direction opposite to the inclination direction (in the clockwise direction) about the center of the read image data as the rotation center point in order to cancel the inclination. As illustrated in the right part of FIG. 10, when the inclination correction process is performed, the part that is not read (the missing part) may become conspicuous. In the document sheet D having no or little margin outside a picture or a figure, the missing part after the rotation process becomes more conspicuous as the inclination angle is larger. Accordingly, some users may think that the rotation angle should not be so large and it is sufficient that the rotation process is performed in some degree to reduce the inclination.

In the document mixed mode (the different width mixed mode), it is preferred to use different contents of the inclination correction process for the largest width document sheet and for the small width document sheet in consideration of a user's intention. Accordingly, a plurality of types of inclination correction modes are prepared for the inclination correction process of the read image data of the small width document sheet. The operation panel 3 (the touch panel unit 32) according to the embodiment accepts an operation of selecting one of the inclination correction modes when reading in the document mixed mode.

Specifically, a mode selection screen S1 as illustrated in FIG. 9 is prepared. In the mode selection screen S1, one of the first mode and the second mode can be selected. The control unit 5 may control the display panel 31 to display the mode selection screen S1 at a time point when reading of the document sheets D in the different width mixed mode is started. In addition, the inclination correction mode may be set in advance so that the selected mode is stored in the storage unit 6, and the inclination correction process may be performed in the stored mode when the document sheet D is read in the different width mixed mode.

The first mode is a mode in which the user determines a correction angle that is an angle of rotation and a correction direction that is a direction of rotation while viewing a preview image P. By operation at a display position of a first mode key K1, the first mode can be selected.

The second mode is a mode in which the control unit 5 determines the correction angle and the correction direction in the inclination correction process automatically to a certain degree. By operation at a display position of a second mode key K2, the second mode can be selected. In the second mode, a desired setting method can be selected from a plurality of (four in this embodiment) setting methods having different correction angles (details will be described later). In order to select a desired setting method, the mode selection screen S1 is provided with four radio buttons R1. By touching one of the radio buttons R1, a mode prepared in the second mode can be selected.

(Inclination Correction Process in First Mode)

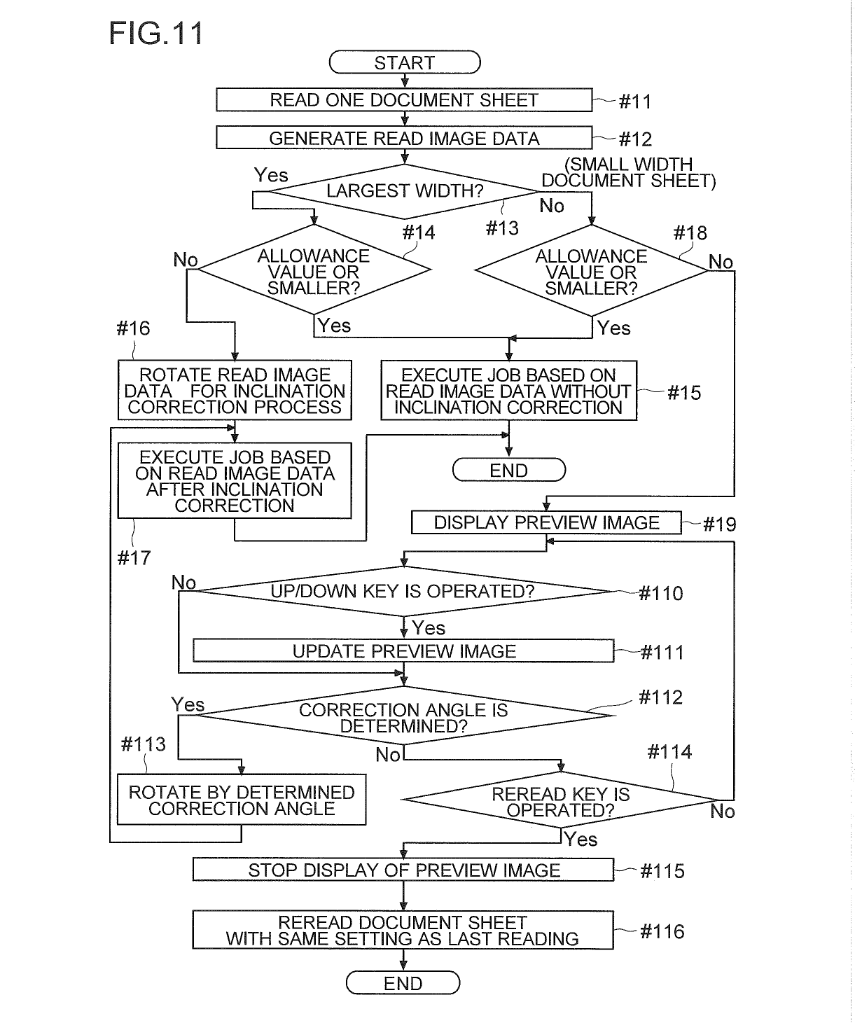

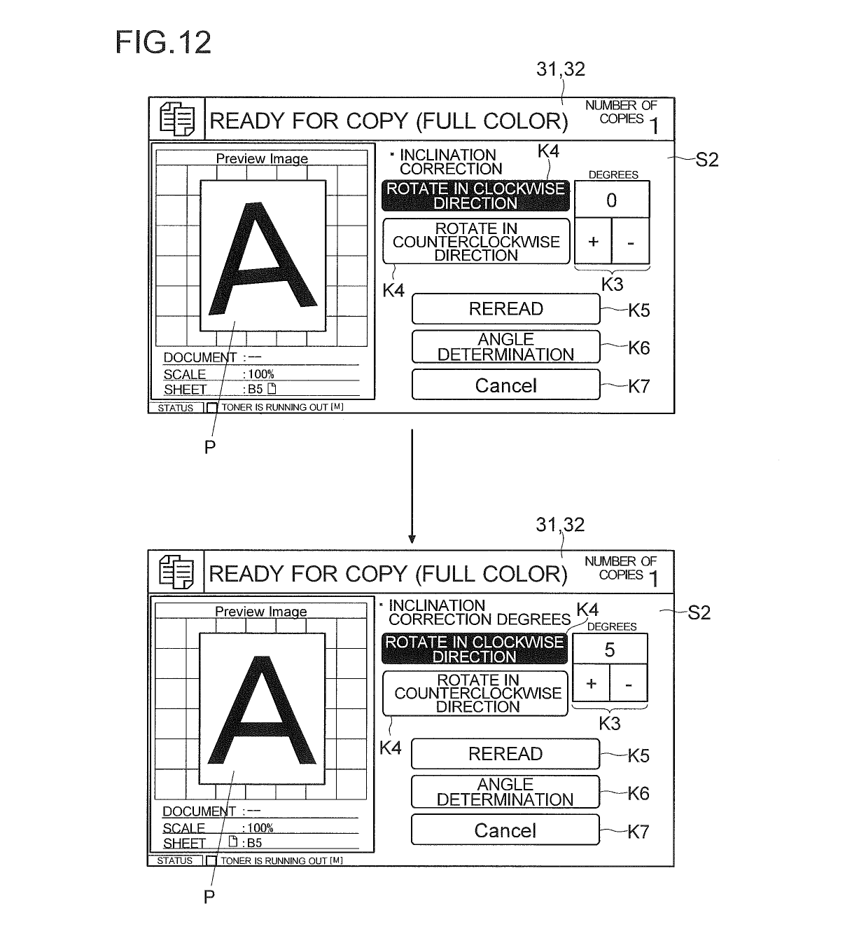

Next, with reference to FIGS. 11 and 12, an example of a flow of the inclination correction process in the first mode performed by the reading device 100 according to the embodiment is described.

First, the flow of FIG. 11 starts at a time point after execution of a job accompanied with reading by feeding the document sheets (copying or scan transmission) in the document mixed mode (the different width mixed mode) is started, the document feeder unit 1 feeds the document sheet D, and the image reading unit 2 starts to read the fed document sheet D. In addition, the setting of determining the correction angle is made in the first mode. Note that the flow of FIG. 11 is performed for each of the document sheets D. Accordingly, when a plurality of document sheets D are continuously fed, the processes of the flow of FIG. 11 are performed in parallel.

The control unit 5 detects the document size, the inclination direction, and the inclination angle while reading one document sheet D (Step #11). Further, the first image processing unit 71 generates read image data of the read document sheet D (Step #12). Next, the control unit 5 checks whether or not the read document sheet D is a sheet having the largest width in the main scanning direction among the document sheets D set on the document tray 11 (Step #13). When it is the largest width document sheet (Yes in Step #13), the control unit 5 checks whether or not the inclination angle is a predetermined allowance value or smaller (Step #14).

The allowance value is a value for determining whether or not to print the read image data without the inclination correction process. The allowance value is in a range that can be appropriately determined. For instance, when the main scanning direction (perpendicular to the document feed direction) is zero degrees, the allowance value can be approximately 0.5 to 1 degrees both in the clockwise direction and in the counterclockwise direction. In addition, the allowance value may be determined with reference to an angle recognized to be inclined by a human being.

When the inclination angle is the allowance value or smaller (Yes in Step #14), the control unit 5 controls to execute the job on the basis of the read image data without the inclination correction process (Step #15 to END). Specifically, the control unit 5 controls the second image processing unit 72 to generates the image data to be used for the job without performing the inclination correction process on the read image data. Further, the control unit 5 controls to print on the basis of the generated image data when the job is the copy job. In addition, the control unit 5 controls the communication unit 52 to transmit the generated image data when the job is the scan transmission job.

On the other hand, when the document sheet has the largest width and when the inclination angle is larger than the allowance value (No in Step #14), the control unit 5 controls the second image processing unit 72 to perform the process of rotating the read image data in the direction of reducing the inclination by a predetermined angle or until the inclination angle becomes zero (the inclination correction process) (Step #16). When the document sheet has the largest width, the inclination angle is usually within approximately 2 degrees both in the clockwise direction and in the counterclockwise direction. Accordingly, the predetermined angle can be larger than 1 degree and smaller than or equal to 2 degrees. In addition, the control unit 5 may control the second image processing unit 72 to perform a process of rotating the read image data by the inclination angle in the direction opposite to the determined inclination direction, so that the inclination becomes zero. Further, the control unit 5 controls the printing unit 4 or the communication unit 52 to execute the job on the basis of the read image data after the inclination correction process (Step #17 to END).

On the other hand, when the document sheet is the small width document sheet (No in Step #13), the control unit 5 checks whether or not the inclination angle is the predetermined allowance value or smaller (Step #18). When the inclination angle is the predetermined allowance value or smaller (Yes in Step #18), the flow proceeds to Step #15. It is because the inclination correction process is not required when the inclination of the small width document sheet in reading is an amount that can be neglected.

On the other hand, when the inclination angle of the small width document sheet is larger than the allowance value (No in Step #18), the control unit 5 controls a display unit to display the preview image P showing a content of the read image data (Step #19, see FIG. 12). Specifically, the control unit 5 controls the second image processing unit 72 (or the first image processing unit 71) to perform a compressing process or a thinning process of the read image data so as to generate image data for the preview display, and the generated image data is given to the operation panel 3. In this way, the user can visually recognize a degree of the inclination of the read image data.

FIG. 12 illustrates an example of a result check screen S2 of the small width document sheet. The display panel 31 displays the preview image P on a left side of the result check screen S2. In addition, the display panel 31 displays an up/down key K3 and a rotation direction key K4 on an upper right side in the result check screen S2. In addition, the display panel 31 displays a reread key K5, a correction angle determining key K6, and a cancel key K7 on a lower right side in the result check screen S2.

The up/down key K3 is a combination of two keys having signs “+” and “−”, respectively. The up/down key K3 is used for determining the rotation angle (the correction angle) of the read image data in the inclination correction process to be performed. The control unit 5 controls the display panel 31 to increase or decrease the correction angle value in a display box in accordance with an operation of the up/down key K3. In addition, two of the rotation direction key K4 are disposed and are used for determining the rotation direction (the correction direction) in the rotation process of the read image data. It is necessary to select one of the two rotation direction keys K4.

The correction angle determining key K6 is used for determining the correction angle of the read image data whose preview image P is displayed. The control unit 5 recognizes a value in the display box at a time point when the correction angle determining key K6 is operated as the correction angle (the correction angle in the rotation process) in the correction direction selected at the time point when the correction angle determining key K6 is operated.

The reread key K5 is used for canceling the current read image data and performing reading again so as to obtain read image data with no or little inclination. The control unit 5 recognizes an operation to the reread key K5 on the basis of an output of the touch panel unit 32.

Note that the reread key K5 may always be displayed when the result check screen S2 is displayed, or may be displayed only when the inclination angle of the small width document sheet is larger than a reference value (both in the clockwise direction and in the counterclockwise direction). Note that the reference value is larger than the allowance value. As described above, a part of document D may be missing in the image data obtained by reading because of the reading in an inclined state. When the document sheet is inclined to such an extent that causes the missing part, it may be preferred to read again. On the other hand, when the inclination angle is not so large, the inclination correction process can sufficiently compensate for the missing part in many cases. Accordingly, it is possible to display the reread key K5 only when the inclination angle is larger than the reference value.

The control unit 5 checks whether or not the up/down key K3 is operated (Step #110). When the up/down key K3 is operated (Yes in Step #110), the control unit 5 controls the second image processing unit 72 to generate image data for the preview image of the read image data in a case of being rotated by the correction angle value after increasing or decreasing in the selected rotation direction. Further, the display panel 31 displays the preview image P on the basis of the generated image data (Step #111). In other words, every time when the up/down key K3 is operated, the control unit 5 controls the display panel 31 to update and display the preview image P corresponding to the read image data after the inclination correction process by the correction angle after the update (Step #111).

In FIG. 12, the upper screen is an example of the result check screen S2 when the correction angle is zero, while the lower screen is an example of the result check screen S2 when the rotation direction is set to the clockwise direction and the correction angle is set to 5 degrees by an operation of the up/down key K3. The inclination is reduced more in the lower screen than in the upper screen of FIG. 12. In this way, the user operates the up/down key K3 so as to find the correction angle and the correction direction such that the inclination becomes zero or substantially zero while viewing the updated preview image P.

In case of No in Step #110, and after Step #111, the control unit 5 checks whether or not the correction angle determining key K6 is operated (Step #112). When the correction angle determining key K6 is operated (Yes in Step #112), the control unit 5 controls the second image processing unit 72 to perform the rotation process (the inclination correction process) on the read image data of the small width document sheet by the correction angle set by the operation unit in the selected correction direction (Step #113). Further, the flow proceeds to Step #17 (to END).

In case of No in Step #112, the control unit 5 checks whether or not the reread key K5 is operated (Step #114). When the reread key K5 is operated (Yes in Step #114), the control unit 5 controls the display panel 31 to stop the display of the result check screen S2 (the preview image P) (Step #115). Further, after all document sheets D set on the document tray 11 are read, the control unit 5 controls the display panel 31 to display a screen urging reset and reread of the document sheet D for which the reread key K5 is operated. As a result, the image reading unit 2 rereads the document sheet D of a page for which the reread key K5 is operated, in the same setting as the last reading (Step #116 to END). On the other hand, when the reread key K5 is not operated (No in Step #114), the flow returns to Step #110.

Here, this flow is executed for each page of the document sheets D. Accordingly, when there are two or more pages of the small width document sheets set on the document tray 11 and when there are two or more document sheets D read in an inclination angle larger than the allowance value, the display panel 31 displays the result check screen S2 (the preview image P) of the next small width document sheet after completion of the display of the result check screen S2 of the first small width document sheet. In this way, the control unit 5 controls the display panel 31 to display the result check screen S2 corresponding to each of the small width document sheets that requires setting of the correction angle.

In addition, it takes some period of time to set the correction angle of one page of the document. Feeding and reading of document sheets remaining on the document tray 11 are continued while the result check screen S2 is displayed. As a result, the control unit 5 controls the printing unit 4 to print first without the inclination correction process for the read image data having the inclination angle of the allowance value or smaller. In other words, the control unit 5 controls to perform print output, in prior to the document sheet D as an object of the result check screen S2, on the basis of the read image data of the largest width document sheet after the result check screen S2 or the read image data of the small width document sheet having the inclination angle of the allowance value or smaller.

(Inclination Correction Process in Second Mode)

Next, with reference to FIGS. 9, 13, and 14, an example of a flow of the inclination correction process in the second mode of the reading device 100 according to the embodiment is described.

The reading device 100 has a plurality of modes having different correction angle setting methods in the second mode (in which the control unit 5 automatically sets the correction angle). The user can select one of the modes so that a desired result can be obtained.

Specifically, a correction priority mode, a correction relief mode, a correction inhibition mode, and a margin recognition mode are prepared as the modes in the second mode, which are used when the inclination angle of the small width document sheet is larger than the reference value. When the rotation angle is large, the missing part of the document sheet D (which was not read due to the inclination) may be conspicuous. Accordingly, a plurality of modes are prepared. Then, the user can select a mode by operating the radio button R1 in the mode selection screen S1 illustrated in FIG. 9. In addition, the display panel 31 may display a screen for selecting a mode every time of reading the small width document sheet having an inclination larger than the reference value.

The reference value is larger than the allowance value. Specifically, the reference value can be a few degrees (e.g., 2 degrees) in either the clockwise direction or the counterclockwise direction with respect to the main scanning direction as zero degrees. When the small width document sheet is inclined in the clockwise direction or the counterclockwise direction by a degree larger than the reference value, the user is guided to select a method of setting the correction angle.

Specifically, the correction priority mode is a mode for performing the inclination correction process in which the read image data is rotated in the direction opposite to the inclination direction so that the inclination angle becomes zero, when the inclination angle of the small width document sheet is larger than the reference value. It is a mode for rotating the read image data by the inclination angle in the direction opposite to the inclination direction (in the correction direction) so that the inclination becomes zero, when the inclination angle of the small width document sheet is larger than the reference value. For instance, when the read image data is inclined in the clockwise direction by 10 degrees with respect to the main scanning direction, the control unit 5 rotates the read image data in the counterclockwise direction by 10 degrees.

In addition, the correction relief mode is a mode for reducing the inclination by performing the inclination correction process by the reference value as the correction angle, when the inclination angle of the small width document sheet is larger than the reference value. It is a mode for setting the correction angle and the correction direction so that the read image data is rotated in the direction opposite to the inclination direction (in the correction direction) by the reference value, when the inclination of the small width document sheet is larger than the reference value in the clockwise direction or in the counterclockwise direction. For instance, when the reference value is 2 degrees, and when the small width document sheet is inclined in the clockwise direction by 10 degrees with respect to the main scanning direction, the control unit 5 sets 2 degrees as the correction angle and performs the rotation process on the read image data by 2 degrees in the counterclockwise direction.

In addition, the correction inhibition mode is a mode for inhibiting the inclination correction process when the inclination angle of the small width document sheet is larger than the reference value in the clockwise direction or in the counterclockwise direction.

The margin recognition mode is a mode for preventing the image from being outside by the rotation process. When the margin recognition mode is selected, the control unit 5 recognizes margins on sides of the read image data before the inclination correction process. The control unit 5 recognizes in the read image data a low density line, in which the number of pixels having a density higher than a predetermined pixel value (high density pixels) is a predetermined number or smaller and extends from an end to the other. In addition, the control unit 5 recognizes in the read image data a high density line, in which the number of pixels having a density higher than a predetermined pixel value (the high density pixels) is a predetermined number or larger in each of the vertical direction and the horizontal direction. Further, the control unit 5 recognizes a bundle of low density lines as a margin. Further, if any image fills to the end, the control unit 5 determines that there is no margin.

Specifically, the control unit 5 recognizes a bundle of low density lines from the upper side of the read image data downward to a high density line in a left and right direction on the frontmost position side as an upper end margin. In addition, the control unit 5 recognizes a bundle of low density lines from the lower side of the read image data upward to a high density line in the left and right direction on the rearmost position side as a lower end margin. In addition, the control unit 5 recognizes a bundle of low density lines from the left side of the read image data rightward to a high density line in the vertical direction on the leftmost side as a left end margin. In addition, the control unit 5 recognizes a bundle of low density lines from the right side of the read image data leftward to a high density line in the vertical direction on the rightmost side as a right end margin.

Further, the control unit 5 recognizes a margin having a smallest width (the smallest number of lines) among the upper, lower, left, and right margins. Further, in the margin recognition mode, the control unit 5 controls the second image processing unit 72 to perform the inclination correction process with an upper limit (an upper limit angle), which is an angle such that an absolute value of a pixel movement in the width direction of the margin having the smallest width is equal to a value of the smallest width.

The storage unit 6 stores margin data D2 defining the upper limit angle corresponding to a smallest width value of the margin. The control unit 5 refers to the margin data D2 so as to recognize the upper limit angle corresponding to the smallest width of the recognized margin. Further, in the margin recognition mode, when the inclination angle is larger than the upper limit angle in the clockwise direction or in the counterclockwise direction, the control unit 5 controls the second image processing unit 72 to perform the rotation process (the inclination correction process) by the upper limit angle in the direction such that the inclination is reduced.

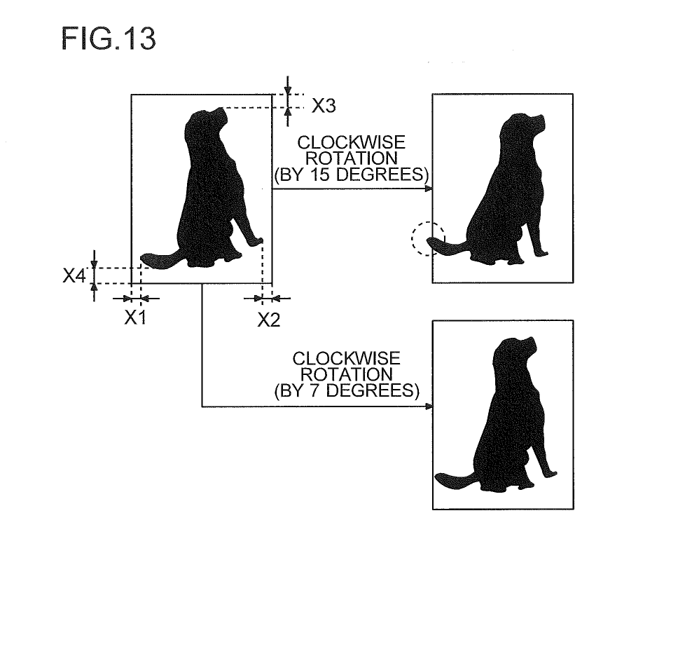

A left side of FIG. 13 illustrates an example of the read image data obtained by reading in an inclined state by approximately 15 degrees in the counterclockwise direction. Further, in the read image data illustrated on the left side of FIG. 13, a margin width on the left end part is denoted by X1, a margin width on the right end part is denoted by X2, a margin width on the upper end part is denoted by X3, and a margin width on the lower end part is denoted by X4. X1 is smallest (shortest) among X1 to X4.

An upper left side of FIG. 13 illustrates an example of the read image data obtained by rotating the read image data by 15 degrees in the clockwise direction about the center of the read image data as the rotation center point in order to correct the inclination. As illustrated in the upper left side of FIG. 13, depending on the correction angle (rotation angle), each pixel movement (movement distance) becomes large (long) due to the rotation so that a part of the image before the conversion may be outside (see a broken line circle on the upper right side of FIG. 13).

Accordingly, as illustrated on the lower right side of FIG. 13, when the margin recognition mode is selected, the control unit 5 controls the second image processing unit 72 to perform the rotation process (the inclination correction process) by an upper limit angle (7 degrees) corresponding to a width of the margin X1 in the direction of reducing the inclination (the clockwise direction in the example of FIG. 13). Further, when the inclination angle is the upper limit angle or smaller, the control unit 5 controls the second image processing unit 72 to perform the inclination correction process of rotating by the correction angle having the same value as the inclination angle in the direction of reducing the inclination (so that the inclination becomes zero).

Further, in any one of the correction priority mode, the correction relief mode, the correction inhibition mode, and the margin recognition mode, regardless of the small width document sheet or the largest width document sheet, when the inclination angle is larger than the allowance value but is the reference value or smaller, the control unit 5 performs the process of rotating the read image data by the correction angle having the same value as the inclination angle in the direction opposite to the inclination direction (the direction of correcting the inclination). For instance, it is supposed that the allowance value is one degree, the reference value is 2 degrees, and the small width document sheet is inclined by 2 degrees in the clockwise direction. Then, the control unit 5 sets 2 degrees as the correction angle and sets the counterclockwise direction as the correction direction.

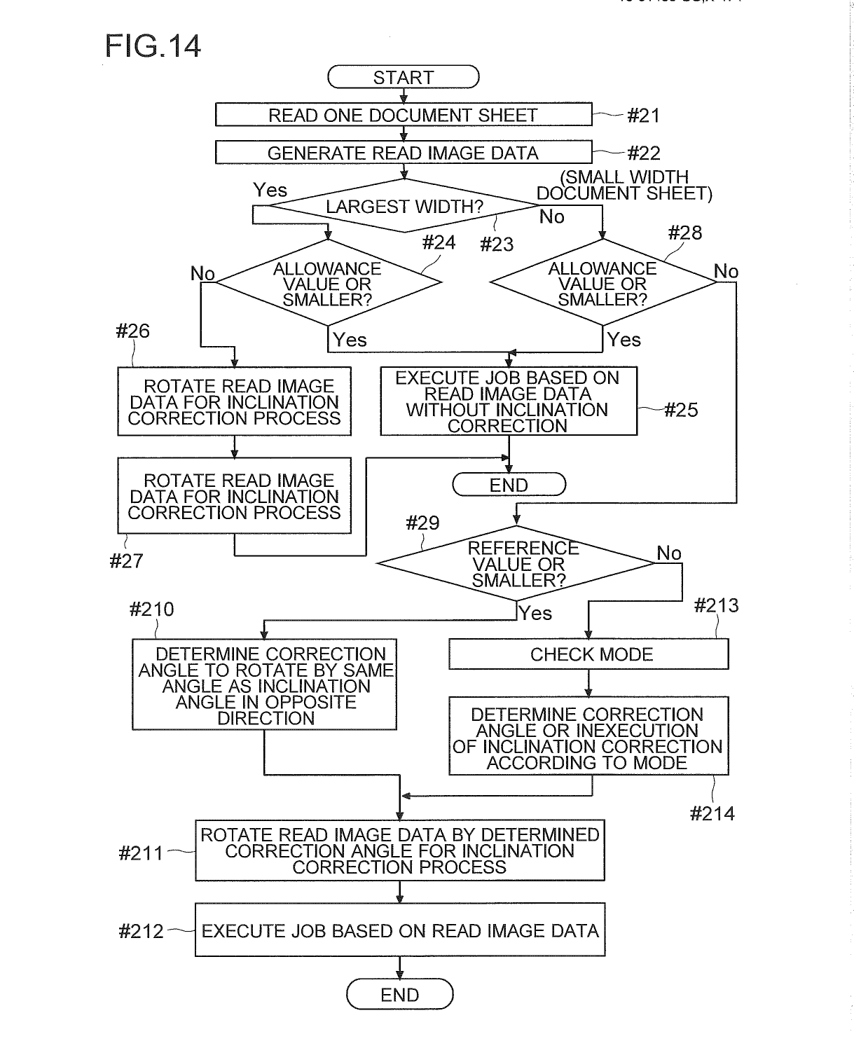

Next, an example of a flow of the inclination correction process in the second mode is described. The flow of FIG. 14 starts when the document feed is performed in the document mixed mode so that execution of a job accompanied with reading by feeding the document sheets (a copy job or a scan transmission job) is started, the document feeder unit 1 feeds the document sheet D, and the image reading unit 2 starts to read the fed document sheet D. In addition, setting of the correction angle is made in the second mode. Note that the flow of FIG. 14 is also executed for each of the document sheets D. Accordingly, when a plurality of document sheets D are continuously fed, processes of the flow illustrated in FIG. 14 are performed in parallel.

Note that Steps #21 to #28 are the same as Steps #11 to #18 in the first mode. Accordingly, description of Steps #21 to #28 is omitted because the description of Steps #11 to #18 can be used instead.

When the inclination angle of the small width document sheet is larger than the allowance value (No in Step #28), the control unit 5 checks whether or not the inclination angle is within the reference value (Step #29). When it is within the reference value (Yes in Step #29), the control unit 5 sets the same value as the inclination angle as the correction angle, and sets the direction opposite to the inclination direction as the correction direction (Step #210). Note that it is possible to rotate by a predetermined angle. Further, the control unit 5 rotates the read image by the predetermined correction angle so as to correct the inclination of the read image data (Step #211). Further, the control unit 5 controls the printing unit 4 or the communication unit 52 to execute the job on the basis of the read image data after the inclination correction process (Step #212 to END).

On the other hand, when the inclination angle of the small width document sheet is larger than the reference value (No in Step #29), the control unit 5 checks a selected mode in the second mode (Step #213). Further, the control unit 5 determines the correction angle or inexecution of the inclination correction process in accordance with the selected mode (Step #214). Further, the flow proceeds to Step #211 (Step #212 to END). Note that the Step #211 is skipped when the inexecution of the inclination correction process is determined because the correction inhibition mode is selected.

In this way, the reading device 100 according to the embodiment includes the operation unit (the touch panel unit 32 and the hardware key 35), the document feeder unit 1, the image reading unit 2, the control unit 5, and the image processing unit (the first image processing unit 71 and the second image processing unit 72). The operation unit accepts a user's operation. The document feeder unit 1 includes the document tray 11 on which the document sheet D is set with the regulation plate 11a for regulating a position of the document sheet D, and the detection sensor unit 18 disposed in the feed path of the document sheet D for detecting a size of the document sheet D, an inclination direction of the document sheet D, and an inclination angle indicating with respect to the main scanning direction, so as to feed the set document sheet to the reading position. The image reading unit 2 reads the document sheet D fed by the document feeder unit 1. The control unit 5 determines an inclination direction and an inclination angle of the document sheet D on the basis of an output of the detection sensor unit 18, and recognizes a size of the document sheet D on the basis of an operation to the operation unit or an output of the detection sensor unit 18. The image processing unit generates read image data as a read result on the basis of the image data generated by the image reading unit 2 and the size of the document sheet D determined by the control unit 5, and performs the inclination correction process of rotating the read image data in the direction opposite to the inclination direction so as to reduce the inclination. The operation unit accepts an operation of selecting one of a plurality of types of inclination correction modes prepared for the inclination correction process of the read image data of the small width document sheet that is the document sheet D having a width smaller than the largest width of the set document sheets D in reading in the document mixed mode in which a plurality of types of document sheets D having different sizes are set on the document tray 11 for reading. In the document mixed mode, the image processing unit performs the inclination correction process for the largest width document sheet in which the read image data is rotated so that the inclination is reduced for the read image data of the largest width document sheet. The image processing unit performs the inclination correction process corresponding to the selected inclination correction mode for the read image data of the small width document sheet.

In this way, it is possible to use different contents of the inclination correction process between for the read image data of the largest width document sheet in which the inclination can be easily suppressed by the regulation plate 11a and for the read image data of the small width document sheet that is apt to be read in an inclined state. In particular, a plurality of inclination correction modes are prepared for the small width document sheet that can be inclined with high probability. In this way, correction of the inclination of the read image data of the small width document sheet can be appropriately performed. In addition, the user can select a content and a mode of the inclination correction process so that a desired content of the inclination correction process can be performed on the read image data of the small width document sheet.

In addition, the reading device 100 includes the display panel 31 for performing display. Further, when the operation unit accepts selection of the first mode that is one of the inclination correction mode, for the user to set the correction angle as the rotation angle and the correction direction as the rotation direction of the inclination correction process, the display panel 31 displays the preview image P indicating a content of the read image data. The operation unit accepts a user's input of setting the correction angle and the correction direction. The image processing unit performs the rotation process on the read image data of the small width document sheet with the correction angle and the correction direction determined by the operation unit. In this way, the user can check the inclination degree and direction of the image data of the small width document sheet by viewing the preview image P. The user can rotate the read image data by the desired angle in the desired direction in view of the inclination degree and direction. Accordingly, the inclination correction process desired by the user is performed.

In addition, the display panel 31 displays the up/down key K3 for increasing or decreasing the correction angle. The operation unit accepts the operation to the up/down key K3 and an operation of finally determining the correction angle and the correction direction. The display panel 31 displays the preview image P corresponding to the read image data after the inclination correction process by a changed correction angle every time when the up/down key K3 is operated. The image processing unit performs the rotation process on the read image data of the small width document sheet by the finally determined correction angle in the finally determined correction direction. In this way, the correction angle can be determined to a desired value by the up/down key K3. The user can easily find an appropriate correction angle while viewing the preview image P that is changed in accordance with the operation to the up/down key K3.

When the rotation process of the image data is performed for correcting the inclination, image quality may be deteriorated, or a part of the image may be outside the frame. Accordingly, the user may want to read the document sheet D again. Conventionally, when reading the document sheet D again, it may be necessary to set again the setting values for reading or to reread all the document sheets D in the document mixed mode. It is bothersome to reread a specific page of the document sheets. Accordingly, the display panel 31 displays the reread key K5 for accepting an instruction to reread the document sheet D corresponding to the preview image P in the display. When the operation unit accepts an operation to the reread key K5, the image reading unit 2 reads the small width document sheet that is set again (with the setting of the last reading). In this way, a specific document sheet D of the document sheets D in the document mixed mode can be easily reread without the bothersome setting or without rereading all document sheets D in the document mixed mode.

In addition, when the operation unit accepts the selection of the second mode as one of the inclination correction modes, in which the control unit 5 determines the correction angle and the correction direction in the inclination correction process, the control unit 5 determines whether or not to perform the inclination correction process, and determines the correction angle and the correction direction, so as to control the image processing unit to perform the rotation process by the determined correction angle in the correction direction on the read image data of the small width document sheet. In this way, the user can obtain the image data after the appropriate inclination correction process without being required to perform a complicated operation and setting.

In addition, the operation unit accepts an input of selecting one of modes in the second mode to be used when the inclination angle of the small width document sheet is larger than the reference value, which include the correction priority mode in which the read image data is rotated as the inclination correction process so that the inclination angle becomes zero, an inclination relief mode in which the inclination correction process is performed by the reference value as the correction angle so that the inclination is reduced, and the correction inhibition mode in which the inclination correction process is not performed. The control unit 5 determines whether or not to perform the inclination correction process in accordance with the selected mode, and determines the correction angle corresponding to the selected mode when determining to perform the inclination correction process. In this way, the user can freely set the content of the inclination correction process. Accordingly, it is possible to perform the automatic inclination correction process desired by the user on the read image data.

In addition, the reading device 100 includes the storage unit 6 for storing data defining the upper limit angle as an upper limit of the correction angle with respect to the smallest width of the margin of the read image data. The control unit 5 recognizes the margin of the read image data of the small width document sheet, determines the smallest width of the margin, and recognizes the upper limit angle corresponding to the determined smallest width. When the inclination angle is larger than the upper limit angle, the control unit 5 determines the upper limit angle as the correction angle and controls the image processing unit to perform the inclination correction process so as to correct the inclination. In this way, the correction angle can be set to the upper limit value such that the content (information) of the read image data is not lost. Accordingly, it is possible to reduce the inclination as much as possible within the range such that the content (information) is not lost.

In addition, the image forming apparatus (the multifunction peripheral 101) includes the reading device 100. Thus, it is possible to provide the image forming apparatus in which inclination of the read image data of the small width document sheet can be appropriately corrected, even if the small width document sheet is set in an inclined state in the document mixed mode. In addition, printing can be performed on the basis of the image data whose inclination is canceled, and hence it is possible to provide the image forming apparatus that generates printed matter without inclination even if the document sheets D are read in the document mixed mode.

In addition, the image forming apparatus includes the reading device 100 having the first mode, and the printing unit 4 for printing on the basis of the read image data. In the copy job, the control unit 5 first controls the printing unit 4 to perform printing without performing the inclination correction process for the read image data having an inclination angle of a predetermined allowance value or smaller, and then controls the printing unit 4 to perform printing on the basis of the read image data after the inclination correction process for the read image data of the document sheet D having an inclination angle larger than the allowance value. In this way, it is possible to first perform printing of a page that does not require the inclination correction process, and afterwards performs printing of a page that may require some period of time until completion of the inclination correction process. Accordingly, it is possible to reduce the period of time until completion of the copy job, compared with a case where printing is performed in turn from the first page after all the document sheets D read in the document mixed mode become ready for copy printing.

Although the embodiment of the present disclosure is described above, the scope of the present disclosure is not limited to the description and can be modified variously within the scope of the spirit of the disclosure.

What is claimed is:

1. A reading device comprising:
a document feeder unit including a document tray on which a document sheet is set with a regulation plate for regulating a position of the document sheet, and a detection sensor unit disposed in a document feeding path so as to detect a document size, a document inclination direction, and a document inclination angle in a main scanning direction, so as to feed the set document sheet to a reading position;
an image reading unit configured to read the document sheet fed by the document feeder unit;
an operation unit configured to receive an operation for selecting one of a plurality of types of inclination correction modes prepared for inclination correction of read image data of a small width document sheet having a width smaller than a largest width of set document sheets in a document mixed mode in which a plurality of types of document sheets having different sizes are set on the document tray for reading;
a control unit configured to determine the document inclination direction and the document inclination angle on the basis of an output of the detection sensor unit, and to recognize the document size on the basis of an operation to the operation unit or the output of the detection sensor unit; and
an image processing unit configured to generate the read image data as a result of reading on the basis of image data generated by the image reading unit and the document size determined by the control unit, to perform a process of decreasing inclination by rotating the read image data in a direction opposite to the inclination direction as an inclination correction process, and in the document mixed mode, to rotate the read image data of a largest width document sheet so that the inclination is decreased as the inclination correction process for the largest width document sheet, while to perform the inclination correction process corresponding to the selected inclination correction mode on the read image data of the small width document sheet.

2. The reading device according to claim 1, further comprising a display panel for performing display, wherein
when the operation unit accepts selection of a first mode as one of the inclination correction modes, for a user to determine a correction angle as a rotation angle and a correction direction as a rotation direction of the inclination correction process,
the display panel displays a preview image indicating a content of the read image data,
the operation unit accepts a user's input for determining the correction angle and the correction direction, and
the image processing unit performs a rotation process on the read image data of the small width document sheet by the correction angle in the correction direction determined with the operation unit.

3. The reading device according to claim 2, wherein
the display panel displays an up/down key for increasing or decreasing the correction angle,
the operation unit accepts an operation to the up/down key and an operation for finally determining the correction angle and the correction direction,
the display panel displays the preview image corresponding to the read image data after the inclination correction process by the correction angle every time when the up/down key is operated, and
the image processing unit performs the rotation process on the read image data of the small width document sheet by the finally determined correction angle in the finally determined correction direction.

4. The reading device according to claim 2, wherein
the display panel displays a reread key for accepting an instruction to reread a document sheet corresponding to the preview image that is displayed, and
when the operation unit accepts an operation to the reread key, the image reading unit reads the small width document sheet that is set again.

5. The reading device according to claim 4, wherein when the operation unit accepts the operation to the reread key, the image reading unit rereads the document sheet of a page for which the reread key is operated in the same setting as the last reading.

6. The reading device according to claim 1, wherein
when the operation unit accepts selection of a second mode as one of the inclination correction mode, for the control unit to determine a correction angle as a rotation angle and a correction direction as a rotation direction of the inclination correction process,
the control unit determines whether or not to perform the inclination correction process as well as the correction angle and the correction direction, and controls the image processing unit to perform a rotation process on the read image data of the small width document sheet by the correction angle in the correction direction.

7. The reading device according to claim 6, wherein
the operation unit accepts an input of selecting one of modes in the second mode to be used when the inclination angle of the small width document sheet is larger than a reference value, including a correction priority mode in which the read image data is rotated so that the inclination angle becomes zero for the inclination correction process, an inclination relief mode in which the inclination correction process is performed by the reference value as the correction angle so that the inclination is decreased, and a correction inhibition mode in which the inclination correction process is not performed, and
the control unit determines whether or not to perform the inclination correction process in accordance with the selected mode, and determines the correction angle corresponding to the selected mode when determining to perform the inclination correction process.

8. The reading device according to claim 6, further comprising a storage unit for storing data defining an upper limit angle as an upper limit of the correction angle with respect to a smallest width of a margin of the read image data, wherein
the control unit recognizes a margin of the read image data of the small width document sheet, determines the smallest width of the margin, recognizes the upper limit angle corresponding to the determined smallest width, determines the upper limit angle as the correction angle when the inclination angle is larger than the upper limit angle, and controls the image processing unit to perform the inclination correction process by the determined correction angle.

9. The reading device according to claim 1, wherein
the detection sensor unit includes a plurality of sensors arranged in a main scanning direction, each of which detects arrival or passage of a paper sheet, and
the control unit holds each time point when each of the sensors detects arrival of the document sheet, determines an inclination angle on the basis of a difference between earliest and last time points among the held time points, and recognizes an inclination direction on the basis of a position relationship between first and last sensors that detected arrival of the document sheet.

10. An image forming apparatus comprising the reading device according to claim 1 and a printing unit for performing printing on the basis of the read image data, wherein
in a copy job, the control unit first controls the printing unit to perform printing without performing the inclination correction process for the read image data having an inclination angle of a predetermined allowance value or smaller, and then controls the printing unit to perform printing on the basis of the read image data after the inclination correction process for the read image data of a document sheet having an inclination angle larger than the allowance value.

11. A method for controlling a reading device, comprising the steps of:
setting a document sheet on a document tray including a regulation plate for regulating a position of the document sheet;
detecting a document size, a document inclination direction, and a document inclination angle in a main scanning direction;
feeding the set document sheet to a reading position;
reading the fed document sheet;
generating read image data as a read result on the basis of image data generated by reading and the detected document size;
performing an inclination correction process of reducing the inclination by rotating the read image data in a direction opposite to the inclination direction;
accepting an operation of selecting one of a plurality of types of inclination correction modes prepared for inclination correction of read image data of a small width document sheet having a width smaller than a largest width of set document sheets in a document mixed mode in which a plurality of types of document sheets having different sizes are set on the document tray for reading;
performing the inclination correction process for a largest width document sheet in which the read image data of the largest width document sheet is rotated so that the inclination is decreased, in the document mixed mode; and
performing the inclination correction process corresponding to the selected inclination correction mode on the read image data of the small width document sheet.
